(19) United States
(12) Patent Application Publication
(10) Pub. No.: US 2016/0196535 A1
(43) Pub. Date: Jul. 7, 2016

(54) DEVICE AND METHOD FOR SMART CALENDAR

(71) Applicant: Electronics and Telecommunications Research Institute, Daejeon (KR)

(72) Inventor: Hee Sook MO, Daejeon (KR)

(21) Appl. No.: 14/988,137

(22) Filed: Jan. 5, 2016

(30) Foreign Application Priority Data
Jan. 5, 2015 (KR) 10-2015-0000539

(51) Int. Cl. G06Q 10/10; G06F 17/22; G06F 17/27; G06F 3/0484

(52) U.S. Cl. CPC G06Q 10/1093; G06F 3/04842; G06F 17/2235; G06F 17/2705

(57) ABSTRACT

Provided is a device and method for a smart calendar. A device for a smart calendar may include a selector to receive a selected date, an extractor to extract a moving region corresponding to the selected date from schedule information registered in a calendar, and a displayer to display weather information on the moving region in an area of the calendar allocated for a weather tab when the moving region differs from a current region in which a user is located.

### CROSS-REFERENCE TO RELATED APPLICATION

This application claims the priority benefit of Korean Patent Application No. 10-2015-0000539, filed on Jan. 5, 2015, in the Korean Intellectual Property Office, the disclosure of which is incorporated herein by reference.

### BACKGROUND

1. Field of the Invention

The present invention relates to a device and method for a smart calendar.

2. Description of the Related Art

With the proliferation of various applications for mobile devices such as smartphones and tablet personal computers (PC), providing information appropriate for a user is being developed.

Widely used applications may include a calendar application to manage a schedule of a user and an application associated with weather and maps to provide information essential for daily life. However, most applications only provide general information in lieu of information customized to a user.

In a case of a calendar application, developing various additional services to be provided, for example, additional information, set to a personal schedule is being attempted. For example, an additional service may be included to provide a visual notification according to a schedule created on a smartphone calendar, and automatically adjust a ringtone and an alarm type by applying a current user status, for example, busy and free.

However, in a case of a general calendar application, following issues may be included.

A general calendar application for providing position-based services may provide limited information on surroundings of a current region due to local and time limitations. Thus, although a user desires domestic and international weather information based on a schedule stored in a calendar, a general technology is limited. Also, although the user desires additional information based on a schedule of the user, such as weather information, health information associated with a health condition of the user, preparedness information, and attention information for daily activities, the general technology does not provide such additional information.

Although the user desires to be provided with various web application services for weather and maps based on the schedule stored in the calendar, the general technology does not provide such services. Therefore, the user is required to perform an additional search and move a screen thereby reducing convenience, association, and effectiveness of information usage.

Thus, development of a method and device for collecting information based on a schedule of a user and displaying the information on a calendar of the user are required.

### SUMMARY

An aspect of the present invention also provides a device and method for a smart calendar that may provide weather information based on a schedule of a user and display customized information for the user in the calendar by providing individualized information including health information based on weather, the schedule of the user, and health condition of the user.

According to an aspect of the present invention, there is provided a device for a smart calendar including a selector to receive a selected date, an extractor to extract a moving region corresponding to the selected date from schedule information registered in a calendar, and a displayer to display weather information on the moving region in an area of the calendar allocated for a weather tab when the moving region differs from a current region in which a user is located.

According to another aspect of the present invention, there is provided a method of a smart calendar including receiving a selected date, extracting a moving region corresponding to the selected date from schedule information registered in a calendar, and displaying weather information on the moving region in an area of the calendar allocated to a weather tab when the moving region differs from a current region in which a user is located.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for a smart calendar using a device for a smart calendar according to an embodiment of the present invention;

FIG. 2 is a diagram illustrating a device for a smart calendar according to an embodiment of the present invention;

FIG. 3 is a diagram illustrating a weather tab in a device for a smart calendar according to an embodiment of the present invention;

FIGS. 4A and 4B are diagrams illustrating examples of health information including a health record according to an embodiment of the present invention;

FIGS. 5A and 5B are diagrams illustrating smart calendars in a device for a smart calendar according to an embodiment of the present invention; and

FIG. 6 is a flowchart illustrating a method for an event smart calendar according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A device and method for a smart calendar described in the present disclosure may collect weather information on a region stored in a schedule based on a health condition and a schedule of a user, and display customized information including health information on a calendar.

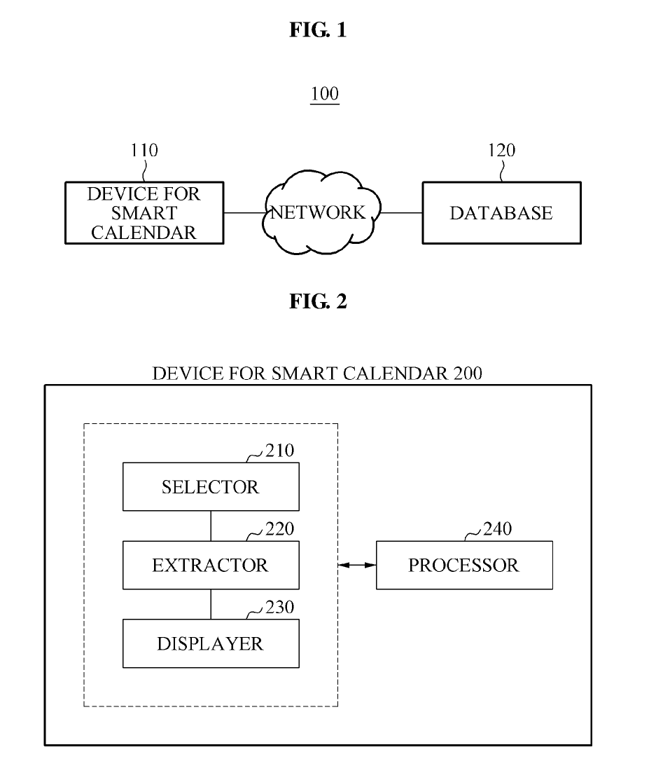

FIG. 1 is a diagram illustrating a system for a smart calendar using a device for a smart calendar according to an embodiment of the present invention.

A system 100 for a smart calendar includes a device 110 for a smart calendar and a database 120.

The device 110 for the smart calendar may be a computer terminal to be connected to a network and the Internet. The device 110 for the smart calendar may be a computer such as a desktop and a kiosk, and a mobile terminal such as a smartphone, a tablet personal computer (PC), and a laptop.

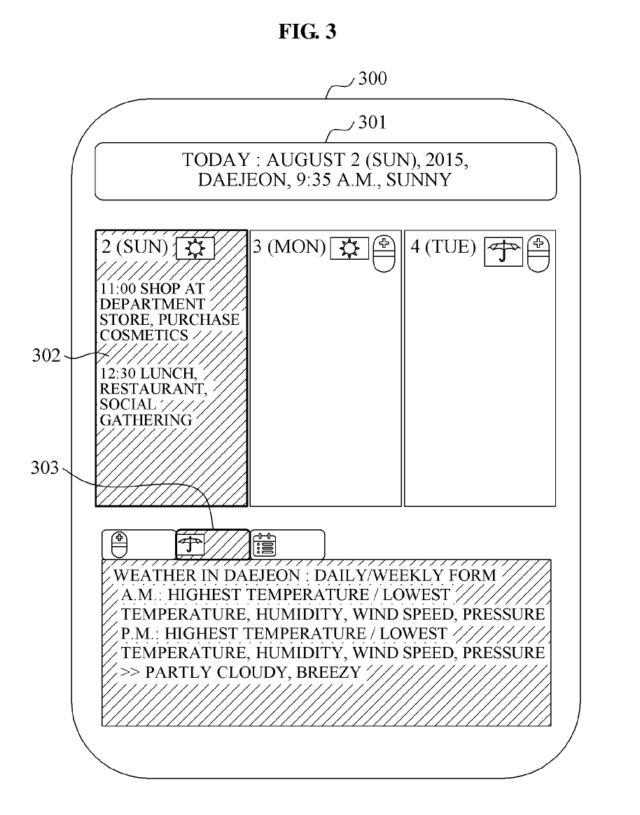

The device 110 for the smart calendar may receive information including at least one of health information, preparedness information, and additional information received from the database 120 and display the information in the device 110 for the smart calendar based on schedule information and weather information. Detailed descriptions about the device 110 for the smart calendar will be provided with reference to FIG. 2.

The database 120 may store at least one of the health information, the preparedness information, and the additional information and transmit, according to a request of the device 110 for the smart calendar, the information to the device 110 for the smart calendar through a network.

FIG. 2 is a diagram illustrating a device for a smart calendar according to an embodiment of the present invention.

A device 200 for a smart calendar according to an embodiment of the present invention includes a selector 210, an extractor 220, and a displayer 230. Also, according to an embodiment of the present invention, the device 200 for the smart calendar further includes a processor 240.

The selector 210 receives a selected date. The selector 210 may receive a date input or selected by a user.

The extractor 220 extracts a moving region corresponding to the selected date from schedule information registered in a calendar. Concisely, the extractor 220 may extract the moving region corresponding to a date selected from the preregistered schedule information.

Here, the extractor 220 performs parsing on data having a location attribute included in the schedule information as the moving region. Concisely, the extractor 220 may extract, from the schedule information, the data associated with a location as the moving region.

For example, when a location at which a scheduled event is stored as “Busan” in schedule information recorded on March 16, the extractor 220 may extract “Busan” having a location attribute as a moving region.

The displayer 230 displays weather information on the moving region in an area of the calendar allocated for a weather tab when the moving region differs from a current region in which a user is located. Concisely, the displayer 230 may display the weather information on the moving region in the weather tab. For example, when a moving region is “Busan” and a current region is “Seoul”, weather information for “Busan” may be displayed in an area of a calendar allocated for a weather tab.

The displayer 230 divides weather information on the current region into any one of daily, weekly, and hourly weather information and displays the divided weather information in the weather tab when the moving region is not extracted from the schedule information or when the moving region corresponds to the current region. Concisely, the displayer 230 may divide weather information on a current region into any one of daily, weekly, and hourly weather information and display the weather information in the weather tab.

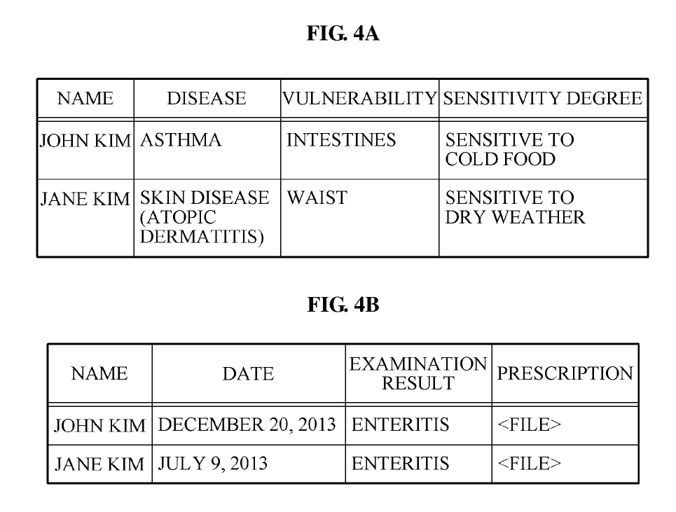

FIG. 3 is a diagram illustrating a weather tab in a device for a smart calendar according to an embodiment of the present invention.

Referring to FIG. 3, the device 200 for the smart calendar may display a calendar 300. However, images, text, and layout of date and weather tabs on the calendar are only examples for ease of description and are not limited thereto.

The device 200 for the smart calendar may display a bar 301 indicating a date of today, a current region, a time, and weather information at upper side of the calendar 300.

When a date August 2 is selected, the device 200 for the smart calendar may display hourly schedule information 302 for August 2. Here, the device 200 for the smart calendar may display an emoticon indicating weather information for August 2.

The device 200 for the smart calendar may display more detailed weather information for August 2 in a weather tab 303 on a lower portion of the calendar 300. For example, since a current region is “Daejeon” and a moving region is also “Daejeon” based on the schedule information 302 for August 2, the device 200 for the smart calendar may display weather information for “Daejeon” in the weather tab 303. In this example, the device 200 for the smart calendar may display hourly weather information corresponding to schedule information. Concisely, since a schedule for August 2 includes schedules for a morning (A.M.) and an afternoon/evening (P.M.), the device 200 for the smart calendar may display weather information including a highest temperature, a lowest temperature, humidity, wind speed, and pressure corresponding to a period of time during the A.M. and the P.M.

Referring back to FIG. 2, the processor 240 collects public health information from a database based on the weather information on the moving region. In this example, the displayer 230 displays the health information in an area of the calendar allocated for a health management tab. Concisely, the processor 240 may collect the health information from the database and collect different health information according to the weather information. The displayer 230 may display the collected health information in a health management tab.

For example, when the moving region corresponds to “Seoul” and the weather information corresponds to “fine dust density, bad”, the processor 240 may collect health information based on the information for “Seoul” and “fine dust density: bad” from the database. When the health information is collected as “sensitive groups for fine dust including seniors, children, and people with asthma: outdoor activity alert”, the displayer 230 may display “sensitive groups for fine dust including seniors, children, and people with asthma: outdoor activity alert” in the health management tab.

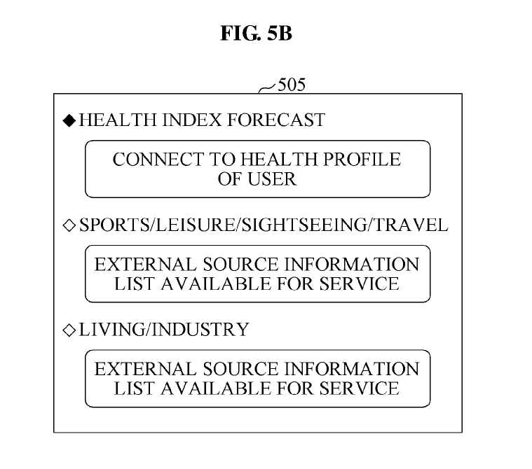

Detailed descriptions of displaying health information on the health management tab will be provided with reference to FIGS. 5A and 5B.

The processor 240 identifies a risk rate with respect to the health information based on a service health index of a user. The displayer 230 adjusts and displays at least one of a color, a shade, and a text size of the health information based on the risk rate.

Here, the service health index may be data in which a sensitivity degree with respect to weather information of the user is converted as numerical values. For example, a service health index may be data in which a degree of vulnerability to a disease in a high humidity climate for an asthmatic user bothered by allergies is converted as numerical values. The processor 240 may calculate the service health index of the user based on a probability analysis algorithm and collect the calculated service health index of the user.

The processor 240 may identify the risk rate with respect to the health information based on the sensitivity degree of the user with respect to the weather information. The displayer 230 may display the health information based on the indentified risk rate by changing a color, adding a shade and differentiating a text size.

Also, the processor 240 identifies, based on the service health index of the user, the risk rate with respect to the health information and alerts the user when the risk rate matches a selected rate. Concisely, the processor 240 may identify the risk rate with respect to the health information according to the sensitivity degree of the user with respect to the weather information and alert the user when the identified risk rate is identified to be greater than or equal to the selected rate.

For example, the processor 240 may identify the risk rate for the asthmatic user bothered by allergies as a “high risk” when a humidity level is greater than or equal to 80%. When the selected rate corresponds to the “high risk”, the processor 240 may alert the user by indicating the “high risk” since the identified risk rate matches the selected rate. The processor 240 may alert the user by sending an alarm in the form of a vibration or an alert sound. Alternatively, the processor 240 may alert the user by adjusting and displaying at least one of a color, a shade, and a text size of when the displayer 230 displays the health information.

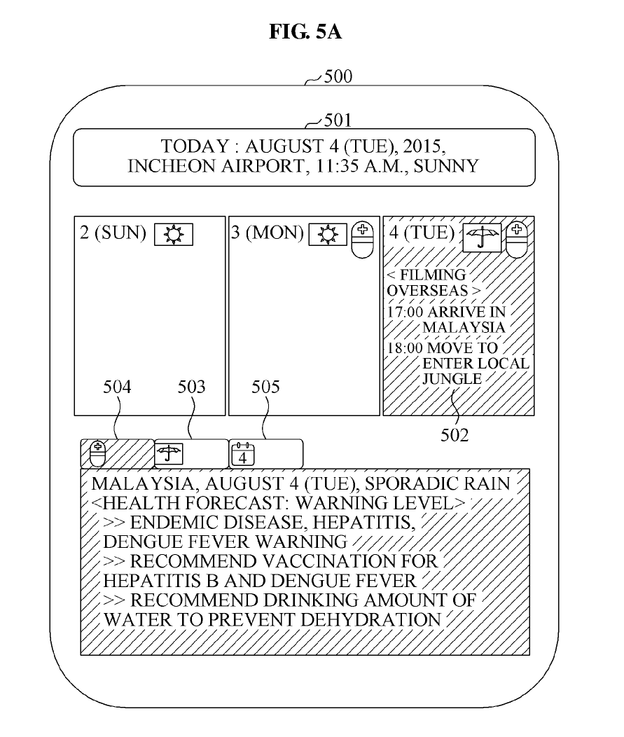

Also, the processor 240 collects the health information including at least one health record of an examination record of the user and a health condition of the user. Concisely, in order to understand an individual feature of the user, the processor 240 may collect the health information including the health record. Detailed descriptions about the health information including the health record will be provided with reference to FIGS. 4A and 4B.

FIGS. 4A and 4B are diagrams illustrating examples of health information including a health record according to an embodiment of the present invention.

Referring to FIG. 4A, the processor 240 may collect the health condition for each user including at least one of a disease, a vulnerability, and a sensitivity degree, as health information. For example, the processor 240 may collect information “disease: asthma, vulnerability: intestines, sensitivity degree: sensitive to cold food”, as information on a user “John Kim”. Also, the processor 240 may collect information “disease: skin disease (atopic dermatitis), vulnerability: waist, sensitivity degree: sensitive to dry weather”, as information on a user “Jane Kim”. The health information for each user may be stored in a database or in the device 200 for the smart calendar. The processor 240 may collect the health information appropriate to the user based on the collected health condition of the user.

Referring to FIG. 4B, the processor 240 may collect an examination record including at least one of a date, an examination result, and a prescription, as health information. For example, the processor 240 may collect an examination record of the user “John Kim” indicating a diagnosis of “enteritis” on Dec. 20, 2013 and Jul. 9, 2014. The examination record of the user may be stored in a database or in the device 200 for the smart calendar. The processor 240 may collect the health information appropriate to the user based on the collected examination record of the user.

Referring back to FIG. 2, the processor 240 collects, based on public safety information or public health information on the moving region, additional information or preparedness information from a database. The displayer 230 displays the additional information or the preparedness information in an area of the calendar allocated for a service tab. Concisely, the processor 240 may collect the additional information or the preparedness information required in the moving region. The displayer 230 may display the additional information or the preparedness information in the service tab.

For example, when parsing is performed on “Africa” and “Africa” is extracted as a moving region, the processor 240 may collect a vaccination list, for example, a malaria vaccination, required for travelling throughout “Africa”, as preparedness information, and the displayer 230 may display the vaccination list in the service tab. Also, the processor 240 may collect safety requirements for travelling throughout “Africa”, as the preparedness information, and collect a relevant emergency call list, as the additional information. The displayer 230 may display the safety requirements and the emergency call list in the service tab.

The displayer 230 displays, in association with the additional information or the preparedness information, a website link providing detailed information on the additional information or the preparedness information, in response to a click. For example, when a vaccination list required for travelling throughout Africa is displayed as preparedness information, the displayer 230 may display a website link of an adjacent hospital in which a vaccination is available.

Also, the processor 240 collects preference information from the user and provides detailed information on the preference information in response to a click by displaying a website link associated with the preference information in an area of the calendar allocated for the service tab. For example, the processor 240 may collect “travel” as preference information with respect to a user and display a website link, for example, an official website of an adjacent tourist attraction, associated with the “travel” information in the service tab.

Detailed descriptions of displaying the additional information, preparedness information, and the preference information will be provided with reference to FIGS. 5A and 5B.

FIGS. 5A and 5B are diagrams illustrating smart calendars in a device for a smart calendar according to an embodiment of the present invention.

Referring to FIG. 5A, the device 200 for the smart calendar displays a calendar 500 including a bar 501 displaying information on today, for example, a current date and a current location, a schedule information area 502 displaying schedule information, a weather tab 503 displaying weather information, a health management tab 504 displaying health information per schedule, and a service tab 505 displaying relative additional information.

The device 200 for the smart calendar may display schedule information for August 4 in the schedule information area 502 when August 4 is selected. For example, schedule information on “filming overseas” may be displayed hourly in the schedule information area 502. The device 200 for the smart calendar may display schedule information hourly, for example, “17:00 arrive in Malaysia, 18:00 move to enter local jungle”. Accordingly, the device 200 for the smart calendar may extract a moving region by performing parsing on data having a location attribute from a schedule for August 4. Concisely, the device 200 for the smart calendar may extract “Malaysia” as the moving region.

The device 200 for the smart calendar may collect and display weather information on the moving region in the weather tab 503, with respect to the selected date. Concisely, the device 200 for the smart calendar may display weather information on Malaysia with respect to August 4, in the weather tab 503. However, referring to FIGS. 5A and 5B, the weather tab 503 may not be the only selection and is only an example for ease of description. When the weather tab 503 is selected, the weather information on Malaysia may be displayed.

The device 200 for the smart calendar may display the health information based on the moving region, the weather information, and the health information of the user in the health management tab 504. When “asthma” and “allergy” are collected as the health information of the user, the device 200 for the smart calendar may collect health information appropriate for a user having “asthma” and “allergy” based on the moving region and weather information. In an example, the device 200 for the smart calendar may collect and display health information, for example, “endemic disease, hepatitis, dengue fever warning”, “recommend vaccination for hepatitis B and dengue fever” and “recommend drinking an amount of water to prevent dehydration” appropriate for a user based on weather information. In this example, the device 200 for the smart calendar may identify and display a risk rate based on a service health index of the user. In another example, the device 200 for the smart calendar may display “health forecast: warning level” in the health management tab 504 in response to a high level of humidity in Malaysia.

The device 200 for the smart calendar may display at least one of the preparedness information, the additional information and the preference information in the service tab 505.

When “ladies professional golf association (LPGA) golf” is collected as the preference information of the user, the device 200 for the smart calendar may display a website link associated with golf in a section “sports/leisure/sightseeing/travel” included in the service tab 505. When the user selects the website link, the device 200 for the smart calendar may display an LPGA event being held nearby that user may watch.

The device 200 for the smart calendar may display the additional information customized for the user in the service tab 505 based on at least one of the schedule information of the user, the health information of the user, the moving region, and the weather information. For example, the device 200 for the smart calendar may display a health profile of the user in a section “health index forecast”. The device 200 for the smart calendar may array and display an external source information list available for a service in a section “living/industry”.

The device 200 for the smart calendar may enable a user to select a probability distribution modeling algorithm or directly input required data to set the additional information to be displayed in the service tab 505. Based on a configuration of the additional information, the device 200 for the smart calendar may initialize a configuration module when booting is performed and collect the additional information to be displayed by connecting with relative information.

The device 200 for the smart calendar may provide weather information based on a schedule of the user and display customized information for the user in the calendar by providing individualized information including health information based on weather, the schedule of the user, and health condition of the user.

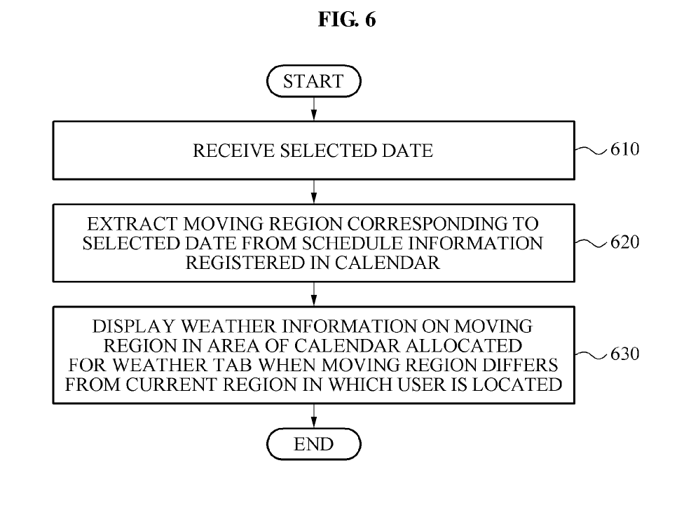

FIG. 6 is a flowchart illustrating a method for an event smart calendar according to an embodiment of the present invention.

The method for the event smart calendar according to an embodiment of the present invention may be performed by the device 200 for the smart calendar.

In operation 610, the device 200 for the smart calendar receives a selected date. Concisely, operation 610 may be an operation in which a date selected or input by a user is received.

In operation 620, the device 200 for the smart calendar extracts a moving region corresponding to the selected date from schedule information registered in a calendar. Concisely, operation 620 may be an operation in which the moving region corresponding to the selected date is extracted from schedule information pre-registered in the calendar.

According to an embodiment of the present invention, the device 200 for the smart calendar may extract the moving region and perform parsing on data having a location attribute included in the schedule information as the moving region. Concisely, the device 200 for the smart calendar may extract the moving region and perform parsing on the data associated with a location.

For example, when a location at which an event is schedule to occur is stored as “Busan” in schedule information recorded on March 16, the device 200 for the smart calendar may extract “Busan” having a location attribute as a moving region.

In operation 630, the device 200 for the smart calendar displays weather information on the moving region in an area of the calendar allocated for a weather tab when the moving region differs from a current region in which a user is located. Concisely, the device 200 for the smart calendar may display the weather information on the moving region in the weather tab in the calendar. For example, when a current location is “Seoul” and a moving region is “Busan”, weather information on “Busan” may be displayed in an area of a calendar allocated for a weather tab.

The device 200 for the smart calendar divides weather information on the current region into any one of daily, weekly, and hourly weather information and displays the divided weather information in the weather tab when the moving region is not extracted from the schedule information or when the moving region corresponds to the current region. The device 200 for the smart calendar may divide the weather information into at least one of daily, weekly, and hourly weather information and display the divided weather information on the current region in the weather tab.

According to an embodiment of the present invention, the device 200 for the smart calendar collects the health information from a database based on the weather information on the moving region and displays the weather information in an area of the calendar allocated for a health management tab. The device 200 for the smart calendar may collect the health information from the database, and collect differing forms of health information according to the weather information. Also, the device 200 for the smart calendar may display the collected health information in the health management tab.

For example, when a moving region is “Seoul” and weather information on “Seoul” corresponds to “fine dust density: bad”, the device 200 for the smart calendar may collect health information based on the information on “Seoul” and “fine dust density: bad” from a database. When the health information is collected as “sensitive groups for fine dust including seniors, children, and people with asthma: outdoor activity alert”, the device 200 for the smart calendar may display “sensitive groups for fine dust including seniors, children, and people with asthma: outdoor activity alert” in a health management tab.

According to an embodiment of the present invention, the device 200 for the smart calendar identifies a risk rate with respect to the health information based on a service health index of a user and adjusts and displays at least one of a color, a shade, and a text size of the health information based on the risk rate.

Here, the service health index may be data on a degree of sensitivity the user has with respect to weather information which is converted as numerical values. For example, a service health index may be data in which a disease vulnerability according to a climate of high humidity with respect to an asthmatic user bothered by allergies is converted as numerical values. The device 200 for the smart calendar may calculate the service health index of the user based on a probability analysis algorithm and collect the calculated service health index of the user.

The device 200 for the smart calendar may identify the risk rate with respect to the health information based on the sensitivity degree of the user with respect to the weather information. The device 200 for the smart calendar may display the health information based on the indentified risk rate by changing a color, adding a shade and differentiating a text size.

According to an embodiment of the present invention, the device 200 for the smart calendar identifies, based on the service health index of the user, the risk rate with respect to the health information and alerts the user when the risk rate matches a selected rate. Concisely, the device 200 for the smart calendar may identify the risk rate with respect to the health information according to the sensitivity degree of the user with respect to the weather information and alert the user when the identified risk rate is identified to be greater than or equal to the selected rate.

For example, the device 200 for the smart calendar may identify the risk rate for the asthmatic user bothered by allergies as a “high risk” when a humidity level is greater than or equal to 80%. When the selected rate corresponds to the “high risk”, the device 200 for the smart calendar may alert the user by indicating the “high risk” since the identified risk rate matches the selected rate. The device 200 for the smart calendar may alert the user by sending an alarm in the form of a vibration or an alert sound. Alternatively, the device 200 for the smart calendar may alert the user by adjusting and displaying at least one of a color, a shade, and a text size of when the displayer 230 displays the health information.

Also, the device 200 for the smart calendar collects the health information including at least one health record of an examination record of the user and a health condition of the user. Concisely, in order to understand an individual feature of the user, the device 200 for the smart calendar may collect the health information including the health record.

According to an embodiment of the present invention, the device 200 for the smart calendar collects, based on public safety information or public health information on the moving region, additional information or preparedness information from a database. The device 200 for the smart calendar displays the additional information or the preparedness information in an area of the calendar allocated for a service tab. Concisely, the device 200 for the smart calendar may collect the additional information or the preparedness information required in the moving region and display the additional information or the preparedness information in the service tab.

For example, when parsing is performed on “Africa” and “Africa” is extracted as a moving region, the device 200 for the smart calendar may collect a vaccination list, for example, a malaria vaccination, required for travelling throughout “Africa”, as preparedness information, and the device 200 for the smart calendar may display the vaccination list in the service tab. Also, the device 200 for the smart calendar may collect safety requirements for travelling throughout “Africa”, as the preparedness information, and collect a relevant emergency call list, as the additional information. The device 200 for the smart calendar may display the safety requirements and the emergency call list in the service tab. The device 200 for the smart calendar displays, in association with the additional information or the preparedness information, a website link providing detailed information on the additional information or the preparedness information, in response to a click. For example, when a vaccination list required for travelling throughout Africa is displayed as preparedness information, the device 200 for the smart calendar may display a link to a website of an adjacent hospital at which a vaccination is available.

Also, the device 200 for the smart calendar collects preference information from the user and provides detailed information on the preference information in response to a click by displaying a website link associated with the preference information in an area of the calendar allocated for the service tab. For example, the device 200 for the smart calendar may collect “travel” as preference information with respect to a user and display a website link, for example, an official website of an adjacent tourist attraction, associated with the “travel” in the service tab.

The method for the event smart calendar according to an embodiment of the present invention may provide weather information based on a schedule of the user and display customized information for the user in the calendar by providing individualized information including health information based on weather, the schedule of the user, and health condition of the user.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to still another aspect of the present invention, nodes in a wireless sensor network may prevent radio frequency interference and dissipation of radio frequency resources when broadcasting communication is performed, increase performance by reducing unnecessary processing of the nodes in the wireless network, and perform minimum necessary communication, thereby extending a lifespan of each node holding limited energy and consequently, extending a lifespan of the wireless system, as a whole.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A device for a smart calendar, the device comprising:
a selector to receive a selected date;
an extractor to extract a moving region corresponding to the selected date from schedule information registered in a calendar; and
a displayer to display weather information on the moving region in an area of the calendar allocated for a weather tab when the moving region differs from a current region in which a user is located.

2. The device of claim 1, wherein:
the displayer divides weather information on the current region into any one of daily, weekly, and hourly weather information and displays the divided weather information in the weather tab when the moving region is not extracted from the schedule information or when the moving region corresponds to the current region.

3. The device of claim 1, further comprising:
a processor to collect health information from a database based on the weather information on the moving region, and
wherein the displayer displays the health information in an area of the calendar allocated for a health management tab.

4. The device of claim 3, wherein:
the processor identifies a risk rate with respect to the health information based on a service health index of a user, and
the displayer adjusts and displays at least one of a color, a shade, and a text size of the health information based on the risk rate.

5. The device of claim 3, wherein the processor identifies, based on a service health index of a user, a risk rate with respect to the health information and alerts the user when the risk rate matches a selected rate.

6. The device of claim 3, wherein the processor collects the health information comprising at least one health record of an examination record of a user and a health condition of the user.

7. The device of claim 1, further comprising:
a processor to collect, based on public safety information or public health information on the moving region, additional information or preparedness information from a database, and
wherein the displayer displays the additional information or the preparedness information in an area of the calendar allocated for a service tab.

8. The device of claim 7, wherein the displayer displays, in association with the additional information or the preparedness information, a website link providing detailed information on the additional information or the preparedness information, in response to a click.

9. The device of claim 1, further comprising:
a processor to collect preference information from a user and provide detailed information on the preference information in response to a click by displaying a website link associated with the preference information in an area of the calendar allocated for a service tab.

10. The device of claim 1, wherein the extractor performs parsing on data having a location attribute included in the schedule information as the moving region.

11. A method of a smart calendar, comprising:
receiving a selected date;
extracting a moving region corresponding to the selected date from schedule information registered in a calendar; and
displaying weather information on the moving region in an area of the calendar allocated to a weather tab when the moving region differs from a current region in which a user is located.

12. The method of claim 11, further comprising:
dividing weather information on the current region into any one of daily, weekly, and hourly weather information and displaying the divided weather information in the weather tab when the moving region is not extracted from the schedule information or when the moving region corresponds to the current region.

13. The method of claim 11, further comprising:
collecting health information from a database based on the weather information on the moving region; and
displaying the health information in an area of the calendar allocated for a health management tab.

14. The device of claim 13, further comprising:
identifying, based on a service health index of a user, a risk rate with respect to the health information, and
wherein the displaying of the health information comprises adjusting and displaying at least one of a color, a shade, and a text size of the health information based on the risk rate.

15. The method of claim 13, further comprising:
identifying, based on a service health index of a user, a risk rate with respect to the health information; and
alerting the user when the risk rate matches a selected rate.

16. The method of claim 13, wherein the collecting of the health information comprises collecting the health information comprising at least one health record of an examination record of a user and a health condition of the user.

17. The method of claim 11, further comprising:
collecting, based on public safety information or public health information on the moving region, additional information or preparedness information from a database; and
displaying the additional information or the preparedness information in an area of the calendar allocated to a service tab.

18. The method of claim 17, further comprising:
displaying, in association with the additional information or the preparedness information, a website link providing detailed information on the additional information or the preparedness information, in response to a click.

19. The method of claim 11, further comprising:
collecting preference information from a user; and
providing detailed information on the preference information in response to a click by displaying a website link associated with the preference information in an area of the service tab allocated to a service tab.

20. The method of claim 11, wherein the extracting of the moving region comprises performing parsing on data having a location attribute included in the schedule information as moving region.
